(19) United States
(12) Patent Application Publication
(10) Pub. No.: US 2022/0281166 A1
(43) Pub. Date: Sep. 8, 2022

(54) METHOD FOR ADDITIVE MANUFACTURE OF A PRODUCT, MANUFACTURING DEVICE AND SOLID PHARMACEUTICAL DOSAGE FORM

(71) Applicant: MERCK PATENT GMBH, DARMSTADT (DE)

(72) Inventor: Malte BOGDAHN, Darmstadt (DE)

(73) Assignee: MERCK PATENT GMBH, DARMSTADT (DE)

(21) Appl. No.: 17/634,739

(22) PCT Filed: Aug. 7, 2020
(86) PCT No.: PCT/EP2020/072297

§ 371 Date: Feb. 11, 2022

(30) Foreign Application Priority Data
Aug. 14, 2019 (EP) 19191661.8

(51) Int. Cl. B29C 64/182; B33Y 10/00; B33Y 30/00; B29C 64/153; B29C 64/268; B29C 64/282

(52) U.S. Cl. CPC B29C 64/182; B33Y 10/00; B33Y 30/00; B29C 64/153; B29C 64/268; B29C 64/282; B29L 2031/753

(57) ABSTRACT

A Method for additive manufacture of a product containing a layer arrangement step, where a layer of small particles of a product material is arranged, a solidification step, where a laser beam is directed at predefined spots within the layer of small particles for heating and connecting the small particles, resulting a solidified area of product material within the layer, and repeatedly performing the layer arrangement step and the solidification step, where each solidified area of product material of the layer is connected with a previously solidified part of the product until the product is generated by interconnected solidified areas of connected product material. The laser beam is divided into at least two separate subbeams that are directed at separate spots for simultaneously connecting the small particles of the product material at these separate spots. The separate subbeams are directed at separate spots at a distance towards each other.

### TECHNICAL FIELD

The invention relates to a method for additive manufacture of a product, comprising a layer arrangement step, whereby a layer of small particles of a product material is arranged, and comprising a solidification step whereby a laser beam is directed at predefined spots within the layer of small particles for heating and connecting the small particles of the product material at said spots, resulting in at least one solidified area of product material within the layer of small particles, and whereby the product is manufactured by repeatedly performing the layer arrangement step and the solidification step, whereby each solidified area of product material of a subsequently arranged layer is connected with a previously solidified part of the product until the product is generated by interconnected solidified areas of connected product material.

### BACKGROUND OF THE INVENTION

Some years ago, additive manufacturing was developed for manufacturing of functional prototypes in support of product development. Nowadays, additive manufacturing is considered an industrial production technology that becomes more and more important and increasingly used for the production of products. The term additive manufacturing summarizes any of various processes in which material is joined or solidified under computer control to create a three-dimensional object. Many manufacturing processes are based on the product material being provided as small particles that are arranged in layers and solidified in layers, whereby subsequently manufactured solidified layers are combined and connected to create the desired product. Such products generated by additive manufacturing can have a very complex shape or geometry and are usually produced starting from a digital 3D model or a CAD file.

There are many different additive manufacturing processes known from prior art that can be used for generating a product by solidifying small particles of product material. Selective laser sintering is an additive manufacturing technique that uses a laser as the power source to sinter powdered material, aiming the laser automatically at points in space defined by a 3D model, binding the material together to create a solid structure. It is similar to direct metal laser sintering; the two are instantiations of the same concept but differ in technical details. Selective laser melting uses a comparable concept, but in selective laser melting the material is fully melted rather than sintered, allowing different properties for the product generated by selective laser melting.

Today, solid oral pharmaceutical dosage forms are usually manufactured via compression of a powder of the product material, i.e. solid particles of the active ingredient mixed with the excipient which is a substance formulated alongside the active ingredient of a medication, included for different purposes such as long-term stabilization or bulking up solid formulations that contain potent active ingredients in small amounts, or to confer a therapeutic enhancement on the active ingredient in the final dosage form, such as facilitating drug absorption, reducing viscosity, or enhancing solubility. High productivity and manufacturing speed can be achieved with rotary tableting machines resulting in low production costs for large batches of the solid oral pharmaceutical dosage forms. Rotary tablet presses use parallelization to achieve high production speed while additive manufacturing requires multiple solid administration forms to be manufactured in a sequential manner.

However, those tablet pressing techniques lack flexibility and require high efforts for processing development and product change including time and raw material. Additive manufacturing techniques blurs the borders between process development, small scale manufacturing and large-scale manufacturing in other industries. Commercially available machines suitable for selective laser sintering uses one to four individually controlled laser sources to simultaneously generate up to four products. A disadvantage is the costs of those machines, which increase with every additional laser source. Each laser beam also requires a distinct beam directing device increasing the costs and required space for the machine.

Accordingly, there is a need to allow for simultaneous generation of many products without significantly increasing production costs and without increasing the total manufacturing time required for generating the many products.

### SUMMARY OF THE INVENTION

The present invention relates to a method for additive manufacture of a product as described above, whereby within the solidification step the laser beam is divided into at least two separate subbeams that are directed at separate spots for simultaneously connecting the small particles of the product material at these separate spots. For many product materials, the laser beam intensity of currently available machines for selective laser sintering or selective laser melting is much higher than required for sintering or melting the small particles of the product material. Thus, it is possible to divide the laser beam into two or more separate subbeams whereby the intensity of each of the subbeams is only a respective fraction of the intensity of the main laser beam generated by the laser source. However, for many product materials and in particular for materials used to generate solid pharmaceutical dosage forms the intensity of a single subbeam suffices to sinter or melt the powder or particles of the respective material to achieve the solidification of the small particles into solidified areas of a small particle layer within the solidification step. Thus, it is possible to divide the laser beam of one laser source up into one or more subbeams that can be used to simultaneously solidify several spots of the product material at the same time.

Within the meaning of the description of this invention, a layer is an amount of product material that covers a surface area of a workspace or a surface area of another layer that is arranged below this layer. The thickness of the layer may vary and the shape of the layer may be curved, but preferably the layer has a uniform thickness that is significantly smaller than the size of the surface that is covered by the layer, and the layer is essentially flat, providing a flat top surface of the layer that allows for adding another flat layer on top of this layer. A spot is a small region of this layer that extends from the top surface of this layer through the thickness of this layer, i.e. until the bottom surface of the layer that opposes the top surface, whereby the size of the spot on the top surface correlates with the size of a cross-section area of a laser beam that illuminates the top surface of the layer. A solidified area is a region of the layer that is composed of one or more spots and comprises solidified product material of the layer within the solidified area. In each layer there must be at least one solidified area after a solidification step for this layer is completed. However, a single layer might comprise more than one solidified area that are at a distance towards each other, but interconnected via another solidified area within another layer above or below this layer. A subbeam is a laser beam that is purposely created by dividing up a laser beam into two or more subbeams with less intensity of laser light than the laser beam. The subbeams can be created by use of any suitable laser beam splitting device. There is no need for a preset or known phase correlation between the subbeams or between any of the subbeams and the laser beam.

The product material layers comprising the small particles that will be solidified within the repeatedly performed solidification steps can be prepared within a powder bed with powder bed material delivery systems well known to a person skilled in the art. Such or similar powder delivery systems are already known and used for additive manufacturing layer technologies. During a layer arrangement step a current top layer can be arranged within a powder bed, either on the working surface of the powder bed or on top of a previous layer that is already present within the powder bed. Then, within a following solidification step a subbeam can be directed onto the surface of the current top layer within the powder bed for solidification of the illuminated small particles within the corresponding spot of current top layer that is illuminated by the subbeam. After solidification of all spots selected for solidification within the current top layer, this layer will become a finished layer comprising one or more solidified areas. Then, a new top layer can be arranged on top of the finished layer within the powder bed by means of the material delivery system.

Only one laser beam source is required for several subbeams, which reduces the total costs required for installing and operating such a machine that allows for solidifying small particles of product material at multiple spots at the same time. The total time required for generation of a number of products is reduced, as the number of simultaneously available subbeams that can be used for solidifying a corresponding number of spots of the small particles of the product material is increased.

According to an advantageous aspect of the invention, the at least two separate subbeams are directed at separate spots at a distance towards each other. The several spots can be used for generation of several products at the same time, i.e. during the same time that is required for generation of a single product. It is possible to generate several products within one layer of small particles, whereby each product is spatially separated from an adjacent product. Then the several subbeams are directed to corresponding spots of the layer. It is also possible to provide for a corresponding number of layers of small particles of the product material arranged at a distance towards each other in a pattern that allows for generation of a corresponding number of products at the same time. Preferably each of the several layers can be arranged within a corresponding powder bed device that is dedicated to the respective layer. Each subbeam must be directed to the respective spot within one layer or subsequently to the respective spots within the several layers of small particles of the product material, resulting in the generation of a corresponding number of products, each of which is generated from the corresponding layer by the respective subbeam directed into the respective layer.

It is also possible to make use of two or more subbeams for manufacture of the same product, resulting in accelerated production speed for the respective product. Thus, two or more subbeams can be directed towards spots at the same layer of small particles to simultaneously solidify several different spots within the same layer, which accelerates the generation of the solidified area within this layer and by consequence the generation of the product that comprises the solidified area or areas of this layer.

According to another aspect of the invention the at least two separate subbeams are directed at separate spots that partially overlap each other. By overlapping two or more subbeams, the resulting laser intensity within the overlapping area of the two or more subbeams is increased. An overlapping area with increased laser light intensity for sintering or melting the small particles of the product material can be used to create different material properties of the solidified product material. For example, it is possible to create several dot-like or strip-like areas of fully molten product material within a layer of sintered product material. The areas with molten and re-solidified product material can be e.g. denser or of better mechanical stability compared to adjacent areas of sintered particles that have been illuminated with only one of the subbeams, i.e. with laser light with reduced intensity.

In order to be able to direct the at least two subbeams to the corresponding spot within the same layer or within at least two spaced apart separate layers of small particles of product material, it is possible to direct the at least two separate subbeams towards separate optical means for directing the corresponding subbeam towards the respective spot on the layer of small particles of the product material. It is possible to direct each subbeam towards a dedicated optical means that is used for controlling the direction of the incoming subbeam towards a corresponding spot for solidifying the small particles of product material within this spot of the layer. The optical means can comprise one or more mirrors, one or more lenses or other optical components that can be used for shaping and directing a laser beam towards a given spot or direction.

The respective optical means can be controlled and operated independent of each other. Thus, it is possible that the position of the respective spots of each of the at least two separate subbeams is controlled independently of each other. Operating and controlling each of the subbeams independent of each other allows for highest possible freedom of manufacturing one single product or many products simultaneously. However, separate optical means for directing the incoming subbeams towards the respective destination requires space and costs for providing the separate optical means.

According to a very advantageous aspect of the invention, the at least two separate subbeams are directed towards one common means for directing at least two of the at least two subbeams towards the respective spots within the layer of small particles of the product material. The common means may comprise a single mirror or lens that directs all incoming subbeams towards the respective spots on the one layer or several layers of product material. Thus, it is easily possible to generate with each of the subbeams a corresponding product that is either generated from the same layer of product material or generated from a corresponding number of layers of product material that are provided by separate layers of product material that are positioned adjacent to each other. As described before, the several layers of product material can be preferably arranged within a corresponding number of powder bed devices arranged adjacent to each other. By using one common means for directing at least two of the at least two subbeams reduces the costs and space requirements of the apparatus that is used for creating and directing the subbeams towards the respective spots for solidifying product material.

According to an embodiment of the present invention, the laser intensity of the at least two subbeams is controlled to connecting the small particles of the product material by sintering the small particles. Methods for sintering the small particles are well known in prior art, and many different methods and parameters are known that allow for sintering small particles of many different product materials. Sintering only requires a part of the beam intensity that is required for fully melting the small particles of most of the product materials. By sintering the product material, it is possible to divide the single laser beam into many more different subbeams that can be directed towards different spots of product material compared to other methods of additive manufacturing a product.

However, for some product materials or for specialized products it can be advantageous to control the laser intensity of the at least two subbeams to connecting the small particles of the product material by melting the small particles in order to connect the small particles by subsequent solidification of the small particle material. Melting the small particles within the spot towards which the subbeam is directed may result in a denser or more durable product. Furthermore, for some product materials sintering is not possible or feasible due to the characteristics of the product material that is used for generating the product.

According to a preferred embodiment of the invention, the product material comprises at least one active ingredient and optionally at least one inactive component for manufacturing a solid pharmaceutical dosage form. It has been found that after dividing the laser beam into several subbeams, the intensity of subbeams are sufficient and suitable for simultaneous manufacturing of a large number of solid pharmaceutical dosage forms that comprise one or more active ingredients. The small particles of the product material can be prepared from a single active ingredient. It is also possible to mix or combine different groups of small particles of two or more different active ingredients resulting in an inhomogeneous or homogeneous product material. Furthermore, one or more inactive components can be added to the product material in order to allow for or to enhance the processability or the resulting characteristic features of the solid pharmaceutical dosage form. Most of the active ingredients or inactive components do not require illumination with high intensity laser beams in order to solidify spots of small particles of the product material that is composed of these active ingredients and inactive components. Furthermore, solid pharmaceutical dosage forms e.g. with a tablet-like shape do not require intricate structures or complex shapes, which facilitates the simultaneous manufacturing of a large number of solid pharmaceutical dosage forms with simple and preferably only few or even one common optical means for all subbeams.

The invention also relates to a manufacturing device for additive manufacturing of a product comprising a laser beam source and a means for directing the laser beam towards a layer of small particles of a product material.

There are many different manufacturing devices that have been developed and successfully adapted and used for various methods of additive manufacturing of products. In order to be able to perform methods like selective laser sintering or selective laser melting, such a device comprises a laser beam source that creates and emits a laser beam that can be used for sintering or melting the loose particles of product material that are arranged in a layer within a manufacturing chamber. The device further comprises means for directing the laser beam from the laser beam source towards a series of predefined spots on the layer of product particles in order to connect the loosely arranged particles by either sintering or melting the particles, resulting in solidifying the particles within the respective spots of product material within the layer. After completing the solidification of all selected spots within this first layer of product particles, a second layer of product particles is loosely arranged above the first layer, and the laser beam is controlled and directed towards spots of the second layer to again solidify selected spots within the second layer, whereby solidified spots of the second layer are also connected to already solidified spots within the first layer. The product is then generated by consecutively adding new layers and connecting the solidified spots of the new layer with already solidified product material from previous layers, until the entire product is manufactured.

However, sequentially directing a laser beam towards a series of spots within a layer of small particles of a product material and heating the small particles within each spot within the layer until the small particles are sintered or molten is very time consuming. Thus, some manufacturing devices comprise several laser beam sources in order to allow for parallelization of the solidification process of several spots of the product material at the same time. This allows for a corresponding reduction of manufacturing time. However, providing and operating several laser beam sources is costly. Usually, the laser beam source and the corresponding means for directing the emitted laser beam towards the selected spots account for most of the costs of such a device. Thus, such a device that comprises several laser beam sources provide for only a small benefit compared to using a corresponding number of devices with a single laser beam source.

Therefore, the present invention also relates to a manufacturing device as described above, whereby the manufacturing device comprises a beam splitting device that divides the laser beam after emission from the laser beam source into at least two separate subbeams that can be directed towards at least two separate spots for simultaneously connecting the small particles of the product material at these separate spots. Thus, it is possible to simultaneously generate at least two separate products, which reduces the time that is required for manufacturing the at least two products to the time that is required for manufacturing a single product. If the laser beam is divided into e.g. 30 subbeams that are directed towards 30 different product areas, the duration of manufacturing 30 products equals the time that is required for manufacturing one product with one subbeam. It is also possible to direct all subbeams towards different spots within the layers of the same product, which reduces the manufacturing time for this product by the factor 30 when compared to the manufacturing of the same product with a common manufacturing device.

It is also possible to combine several laser beam sources within the manufacturing device, whereby at least one laser beam from one laser beam source is directed towards at least one beam splitting device for dividing this laser beam into at least two subbeams. If a product material that is used for generating a product requires a very high intensity of a laser beam, a laser beam that is not divided into several subbeams is used for illumination of the spots. If a product material only requires a fraction of the high intensity laser beam, the subbeams with lower intensity can be used.

Preferably, several or all of the laser beam sources are combined with a corresponding beam splitting device in order to create a large number of subbeams for simultaneously illuminating a corresponding large number of spots of small particles of the product material. It is also possible to direct one or more subbeams towards a following beam splitting device or towards a number of following beam splitting devices in order to split up each incoming subbeam in two or more outgoing subbeams emerging from the following beam splitting devices.

According to an aspect of the invention, the beam splitting device comprises at least one semitransparent mirror that splits the laser beam into at least two separate subbeams that can be directed towards the at least two separate spots on the product material. By arranging one or more semitransparent mirrors along the optical path of the laser beam that is emitted from the laser source, a corresponding number of subbeams can be created. The reflective characteristics of the semitransparent mirrors can be preset in order to create a number of subbeams that have approximately the same intensity, e.g. by arranging semitransparent mirrors with increasing reflectivity along the optical path. A last mirror along the optical path of the laser beam can be fully reflective in order to avoid a further subbeam that is transmitted through the last mirror, but is not used for illuminating a corresponding spot on the product material.

In case that less than the number of subbeams that are created by the beam splitting device with the preset number of semitransparent mirrors are required during manufacture of a product, it is possible to arrange some laser absorbing material along the optical path of one or more subbeams. These subbeams will then be absorbed and do not illuminate a corresponding spot on the product material.

For a better control of the subbeams it is possible to mount the semitransparent mirrors in a manner that allows for pivoting the semitransparent mirrors, which will allow for controlling the direction of the corresponding subbeams that emerge the beam splitting device.

It is also possible according to another aspect of the invention that the beam splitting device comprises a diffraction grating that splits the laser beam into at least two separate subbeams that can be directed towards the at least two separate spots on the product material.

The diffraction grating can be transmissive or reflective for the laser beam. There are many different diffraction gratings known to the persons skilled in the art that allow for dividing the incoming laser beam into either two or three or up to a large number of outgoing subbeams. The beam splitting device may also comprise a focusing lens that focuses the subbeams towards the one or more optical means for directing the laser beam towards one or more layers of small particles of the product material.

In order to allow for individual control of each of the subbeams, the manufacturing device may comprise separate optical means for directing the at least two subbeams towards separate spots on the layer of small particles of the product material. Thus, for each of the subbeams a dedicated optical means for directing and focusing is provided for within the manufacturing device.

According to a preferred embodiment, the manufacturing device comprises one common optical means for directing at least two of the at least two subbeams towards separate spots within the layer of small particles of the product material. This allows for a significant reduction of costs, as only one common optical means is used for directing many subbeams towards separate spots. By using suitable common optical means, it is possible to manufacture as many similar objects as subbeams are simultaneously available.

According to an aspect of the invention, the one or more optical means for directing the at least two subbeams comprise one or more mirrors that reflect the incoming one or more subbeams towards the respective spots. The optical means may include pivotable or multi-directional movable mirrors. The mirrors may be plane mirrors with a flat surface, or curved mirrors with a convex or concave surface, or even with a three dimensionally shaped surface.

According to another aspect of the invention, the one or more optical means for directing the at least two subbeams comprise one or more focusing device for focusing the one or more incoming subbeams onto the respective spots. Such optical means may comprise one or more lenses or a lens system, or any other means for directing and focusing a laser beam.

Each of the optical means can be connected with a control unit that allows for individual and simultaneous control of all optical means. It is also possible to group several or all similar optical means in order to allow for correlated or identical movement or other operation of the grouped optical means.

According to an advantageous embodiment of the invention, the focusing device comprises or is a f-theta lens system. A f-theta lens system allows for simultaneously focusing several subbeams within a flat surface, i.e. within the preferably flat top surface of the layer of small particles. F-theta lenses are designed with a barrel distortion that yields a displacement that is linear with the deflection angle. This simple response removes the need for complicated electronic correction with respect to spots within a uniform and flat layer of small particles, and thus allows for a fast, relatively inexpensive, and compact focusing system.

In case that a single mirror within a single optical means for all the subbeams is used for directing the subbeams towards the corresponding number of spots on the product material, a cost saving method for varying the distance of the respective spots on the product material only requires a corresponding change of the distance between the beam splitting device and the single mirror. If deemed necessary or advantageous, a focus of the subbeams emerging the beam splitting device can be changed as well in order to focus the subbeams onto the single mirror. It is also possible to alter the distance between the single mirror and the top surface of the layer of small particles of the product material, i.e. the illuminated spots on the product material.

According to another embodiment of the invention, the direction of the subbeams emerging from the beam splitting device can be varied in order to vary a distance of the respective spots accordingly. The direction of the subbeams can be varied e.g. by changing the orientation of semitransparent mirrors within the beam splitting device that create the subbeams. It is also possible to arrange for mirrors or other beam direction altering means within the optical paths of the subbeams in order to change the direction of the subbeams towards the optical means that are used for directing the subbeams towards the one or more layers of product material, i.e. towards the respective spots on the product material.

In case that a grating is used for splitting up the incoming laser beam into a number of outgoing subbeams, the grating can be replaced by a different grating with different optical properties, e.g. by a grating with a larger or smaller divergence of the emerging subbeams. Furthermore, different gratings can be used to generate different numbers of subbeams.

It is possible that the laser beam source is a commercially available laser beam source suitable for additive manufacturing methods like selective laser sintering or selective laser melting, e.g. a carbon dioxide laser source, a Nd:YAG laser source or an optical fiber laser source. Such laser beam sources are commonly available with well-known and extensively verified characteristics. There is no need for specially adapted or modified and thus costly laser beam sources. Depending on the product material that is used for the manufacturing of the products in question, there are no extraordinary requirements with respect to the intensity or stability of the laser beam source.

Some common laser beam sources that are suitable for performing additive manufacturing methods like e.g. selective laser sintering or selective laser melting emit laser beams with an intensity of e.g. 70 W. It has been found that it is possible to divide such a laser beam into up to 35 subbeams with a respective intensity of 2 W per subbeam, which is sufficient for manufacturing many different kinds of solid oral pharmaceutical dosage forms.

The invention also relates to a solid pharmaceutical dosage form, whereby the solid pharmaceutical dosage form is manufactured by a method as described above. Furthermore, it is possible to make use of the manufacturing device described above for manufacturing the solid pharmaceutical dosage form.

### BRIEF DESCRIPTION OF THE DRAWINGS

The present invention will be more fully understood, and further features will become apparent, when reference is made to the following detailed description and the accompanying drawings. The drawings are merely representative and are not intended to limit the scope of the claims. In fact, those of ordinary skill in the art may appreciate upon reading the following specification and viewing the present drawings that various modifications and variations can be made thereto without deviating from the innovative concepts of the invention. Like parts depicted in the drawings are referred to by the same reference numerals.

FIG. 1 illustrates a schematic view of a manufacturing device with a laser beam source, with a beam splitting device, with one common optical means for the subdivided subbeams, whereby the one common optical means comprises one reflecting mirror and one focusing lens, and with a powder bed comprising a layer of small particles of product material,

FIG. 2 illustrates a schematic view of a manufacturing device similar to that shown in FIG. 1 with several optical means whereby each of the optical means is dedicated to a corresponding subbeam, and whereby each subbeam is directed to a different spot of small particles that is related to a respective product to be manufactured,

FIG. 3 illustrates a schematic view of the manufacturing device of FIG. 2, whereby the subbeams are directed to partially overlapping spots of small particles within the layer of product material,

FIG. 4 illustrates a schematic view of a manufacturing device with separate mirrors and one common f-theta lens for directing the subbeams towards the layer of small particles of product material,

FIG. 5 illustrates a schematic top view of a layer of small particles of product material, whereby three subbeams each generate a corresponding solid pharmaceutical dosage form,

FIG. 6 illustrates a schematic top view of three separate layers of small particles of product material arranged within three separate powder bed devices, whereby three subbeams each generate one solid pharmaceutical dosage form within the respective layer,

FIG. 7 illustrates a schematic top view of three layers that are arranged within a dedicated powder bed for each layer, whereby each layer comprises ten solid pharmaceutical dosage forms which are generated by three subbeams that have been subdivided from a single laser beam,

FIG. 8 illustrates a schematic top view of a single layer comprising three rows of six solid pharmaceutical dosage forms each, which are generated by three subbeams that have been subdivided from a single laser beam,

FIG. 9 illustrates a schematic view of a part of a modified manufacturing device with a beam splitting device that comprises several semitransparent mirrors, and

FIG. 10 illustrates a schematic view of a part of a modified manufacturing device with a beam splitting device that comprises a grating.

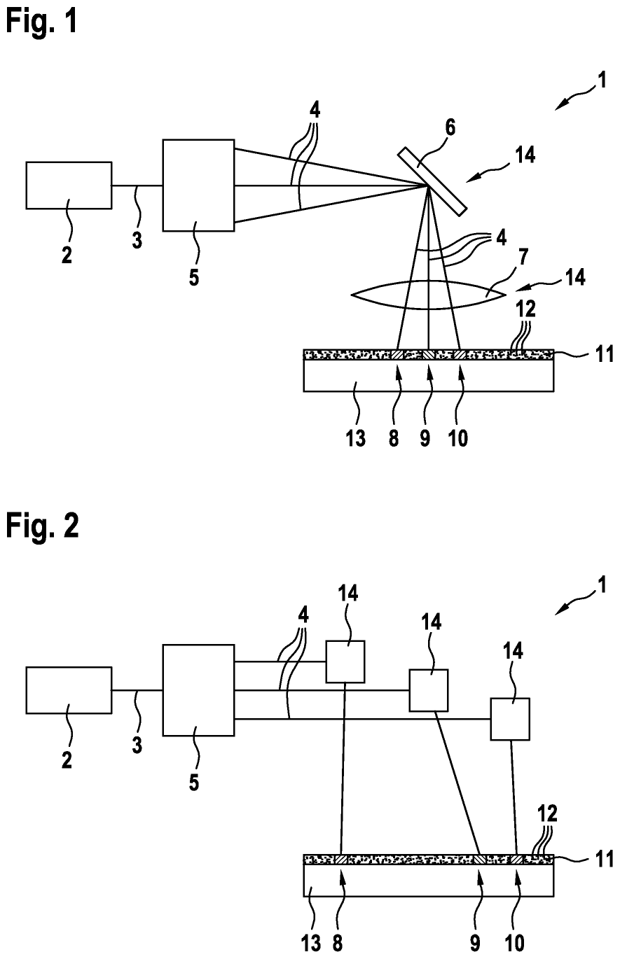

An exemplary embodiment of a manufacturing device 1 that is shown in FIG. 1 comprises a laser beam source 2 that emits a single laser beam 3. The laser beam 3 is divided into three subbeams 4 by a beam splitting device 5. The three subbeams 4 are directed towards a mirror 6. The mirror 6 is a multi-directional movable mirror 6 that is controlled by a control unit not shown in FIG. 1. The orientation of the mirror 6 is such that the three subbeams 4 are directed towards a f-theta lens 7. Due to the different deflecting angles of the three subbeams 4 emitted by the beam splitting device 5, each of the subbeams 4 is directed towards a different spot 8, 9, 10 within a layer 11 of small particles 12 of a product material that has been arranged within a powder bed 13 during a previously performed layer arrangement step. The mirror 6 and the f-theta lens 7 constitute the optical means 14 that are required for directing the three subbeams 4 towards the respective spots 8, 9, 10 within the layer 11 of small particles 12 of the product material.

During a solidification step, each subbeam 4 heats and connects the small particles 12 of the product material within the corresponding spot 8, 9, 10. Dependent on the small particles 12 of the product material and the intensity and duration of the laser beam 3 and by consequence of the three subbeams 4, the small particles 12 can be either sintered or melted during illumination of the respective spots 8, 9, 10 with the corresponding subbeams 4, resulting in a respective solidified spot 8, 9, 10 of product material. By subsequently moving the mirror 6 into other positions or orientations with respect to the layer 11, the subbeams 4 are directed towards other spots 8, 9, 10 within the layer 11 of the product material and perform heating and connecting the small particles 12 within the other spots 8, 9, 10, until all spots 8, 9, 10 within the layer 11 that have to be solidified in order to create a product layer are sufficiently illuminated and solidified by the corresponding subbeams 4.

After all necessary spots 8, 9, 10 within the layer 11 of the product material are illuminated and solidified by the subbeams 4, a new layer of small particles 12 of product material is arranged above the previous layer 11 during a repeated layer arrangement step. Afterwards, during a repeated solidification step all necessary spots 8, 9, 10 within the new layer are heated and connected, i.e. solidified to generate the next product layer. The layer arrangement step and the solidification step are repeatedly performed to generate a growing number of product layers, whereby a new product layer is generated on top of the previous product layer and connected with the previous layer, until the complete product is generated by additive manufacturing.

The manufacturing device 1 of FIG. 1 allows for simultaneous illumination of three different spots 8, 9, 10 within the layer 11 of product material. However, only one laser beam source 2, only one mirror 6 and only one f-theta lens 7 is required for simultaneous illumination of the three different spots 8, 9, 10. With three subbeams 4, it is possible to simultaneously generate three products within a manufacturing time that is required for the generation of a single product. The costs for providing the manufacturing device 1 and for operating the manufacturing device 1 of FIG. 1 are very low compared to the costs for three separate manufacturing devices known from prior art that are required for simultaneous manufacture of three different products.

The manufacturing device 1 of FIG. 1 is suitable for simultaneous manufacturing of three identical products. By dividing the laser beam 3 into more than three subbeams 4, e.g. into 30 subbeams 4, it is possible to simultaneously generate a corresponding number of products, e.g. 30 separate products within the manufacturing time that is required for additive manufacturing a single product.

FIG. 2 illustrates an alternative embodiment of the manufacturing device 1. For each subbeam 4 there is a dedicated optical means 14 for directing and focusing the corresponding subbeam 4 towards the respective spot 8, 9, 10 within the layer 11 of product material. Each optical means 14 may optionally comprise one or more mirrors, one or more lenses, and one or more other optical components that might by helpful for directing and focusing the corresponding subbeam 4 towards the respective spot 8, 9, 10. By providing and operating separate optical means 14 for some or all subbeams 4, the direction of the subbeams 4 can be individually controlled, which allows for a more flexible use of the manufacturing device 1. For example, it is possible to simultaneously generate three different products with different size and shape by individually controlling the respective optical means 14 that control the direction and focusing of a corresponding subbeam 14.

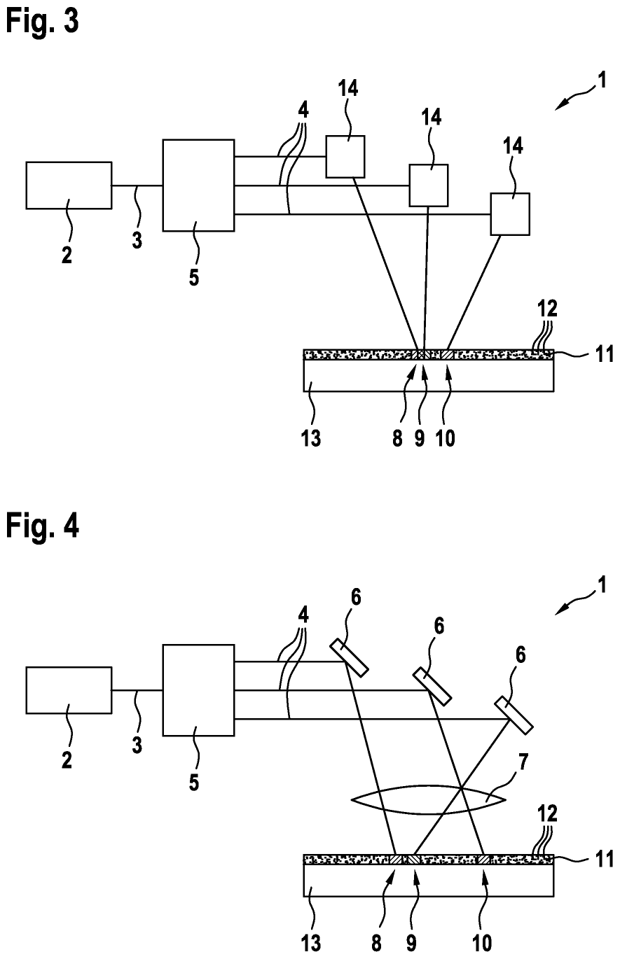

FIG. 3 illustrates the manufacturing device 1 of FIG. 2. Two out of three subbeams 4 are directed to partially overlapping spots 8, 9 within the layer 11 of product material. Illumination of partially or fully overlapping spots 8, 9, 10 can be used in case that for some areas within the layer 11 of product material a higher heating or e.g. melting of the small particles 12 of the product material is required or advantageous.

It is also possible to combine common components of optical means 14 that are used and operated for all subbeams 14 together, with other components of optical means 14 that are dedicated to respective subbeams 4 and allow for individual control or operation of the respective subbeams 4. A manufacturing device 1 shown in FIG. 4 comprises three mirrors 6, whereby for each subbeam 4 a dedicated mirror 6 is positioned and oriented to reflect the corresponding subbeam 4 towards the respective spot 8, 9, 10 within the layer 11 of product material. After being reflected by the respective mirror 6, the three subbeams 4 all travers through a shared f-theta lens 7 which focuses the subbeams 4 at the spots 8, 9, 10. By individually operating and orienting the three mirrors 6, the direction of the three subbeams 4 and thus the position of the respective spots 8, 9, 10 within the layer 11 can be predetermined individually during the solidification steps. Thus, even at reduced costs compared to the manufacturing device as described in FIGS. 2 and 3, it is possible to allow for individual operation of the three subbeams 4 which enables a flexible use of the manufacturing device 1 as shown in FIG. 4.

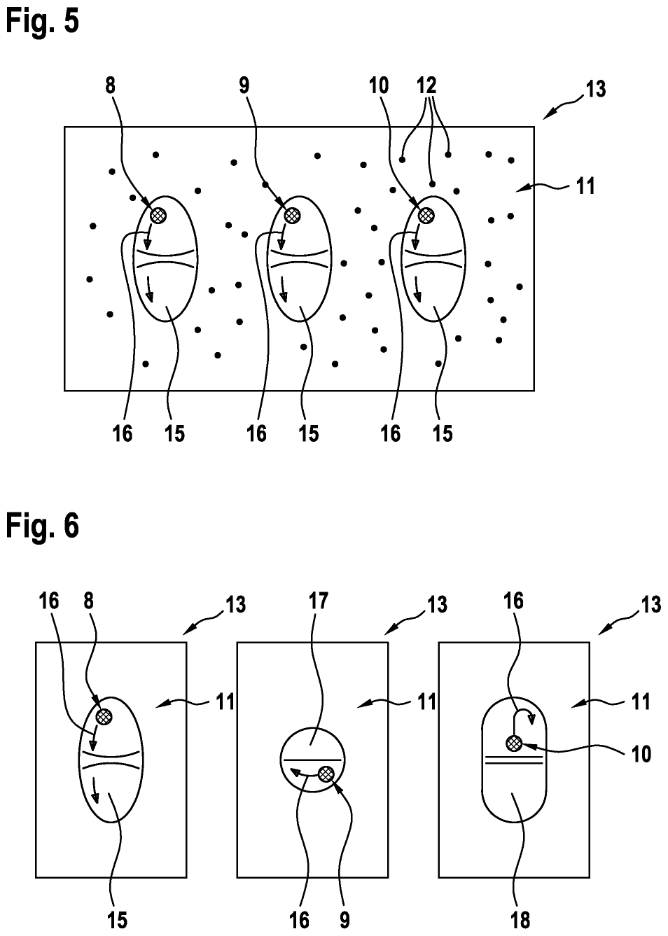

FIG. 5 illustrates a schematic top view onto the layer 11 of small particles 12 of product material of the powder bed 13 of the manufacturing device 1 as shown in FIG. 1. Three identical solid pharmaceutical dosage forms 15 with a respective shape of a tablet are simultaneously generated by the three subbeams 4 that are directed to the respective spots 8, 9, 10 within the layer 11. With each spot 8, 9, 10 a corresponding solid pharmaceutical dosage form 15 is solidified from the small particles 12 of the layer 11 of product material. The three subbeams 4 are directed along identical paths 16 within the respective area of small particles 12 that are solidified to generate the corresponding solid pharmaceutical dosage form 15.

FIG. 6 illustrates a schematic top view onto the layer 11 of product material of three separate powder beds 13 of the manufacturing device 1 as shown in FIGS. 2 and 3. Due to the individual controlling and operation of each subbeam 4, it is possible to generate three different solid pharmaceutical dosage forms 15, 17, 18 with the three spots 8, 9, 10 of the three subbeams 4. Each solid pharmaceutical dosage form 15, 17, 18 can have a different size and a different shape. Due to the different powder beds 13 and respective layers 11 of product material, it is also easily possible to generate each solid pharmaceutical dosage form 15, 17, 18 from different product material.

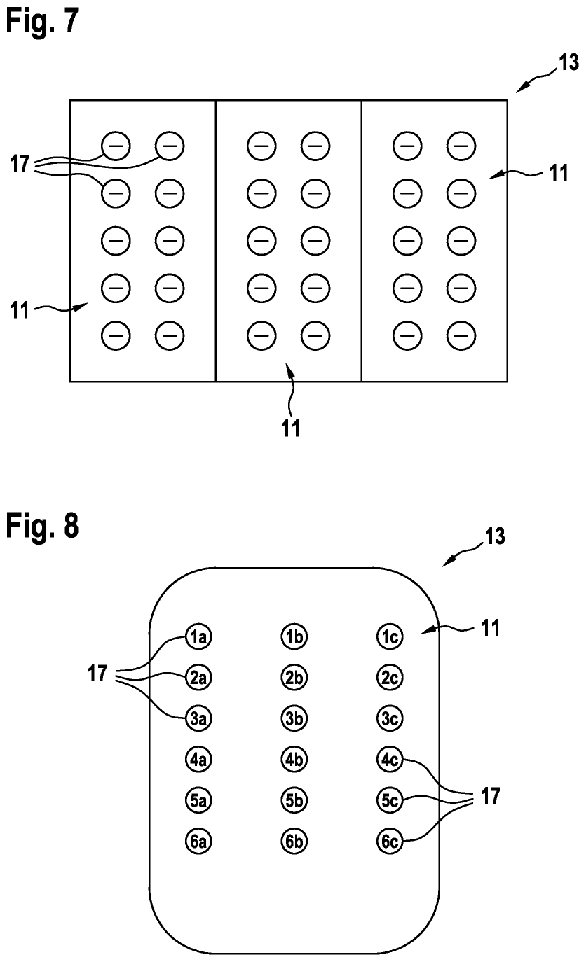

FIG. 7 illustrates a schematic top view onto three layers 11 of product material, whereby each layer 11 is arranged within a corresponding powder bed 13. A large number of thirty identical solid pharmaceutical dosage forms 17 can be additively manufactured with the manufacturing device 1 as shown in FIG. 1. With each subbeam 4, ten solid pharmaceutical dosage forms 17 arranged in two columns and five rows are manufactured.

In case that the manufacturing device 1 allows for dividing the laser beam 3 from the laser beam source 2 into thirty subbeams 4, all of these thirty solid pharmaceutical dosage forms 17 can be manufactured with dedicated subbeams 4 within a duration that is required for additive manufacturing a single solid pharmaceutical dosage form 17 with a prior art manufacturing device with only one laser beam 3.

By making use of three separate powder beds 13, the product material within each layer 11 can be different, which allows for the simultaneous manufacturing of different solid pharmaceutical dosage forms 17 at the same time.

In FIG. 8 a single layer 11 is illustrated that is arranged within a corresponding powder bed 13. Three columns of identical solid pharmaceutical dosage forms 17 are generated by three subbeams 4, whereby each subbeam 4 is directed towards the corresponding column and subsequently generates each solid pharmaceutical dosage form 17 within this column. For the purpose of clarification, the three columns are labeled with small letters a, b, and c, whereas the six solid pharmaceutical dosage forms 17 within each column are numbered with numerals 1 to 6. At the beginning, the three subbeams 4 are used to simultaneously generate the first solid pharmaceutical dosage form 17 within each column, i.e. the three solid pharmaceutical dosage forms 17 labeled 1a, 1b and 1c. Then, the next three solid pharmaceutical dosage forms 17 labeled 2a, 2b and 2c are generated, followed by the solid pharmaceutical dosage forms 17 in the next four rows, until all solid pharmaceutical dosage forms 17 1a up to 6c are finalized.

In case that the intensity of the subbeams 4 is sufficiently high for solidification of the product material in use, it is also possible to create and control 18 subbeams that are simultaneously directed towards respective spots of the layers of all of the 18 solid pharmaceutical dosage forms 17 1a up to 6c, thus generating all of the 18 solid pharmaceutical dosage forms 17 1a up to 6c at the same time.

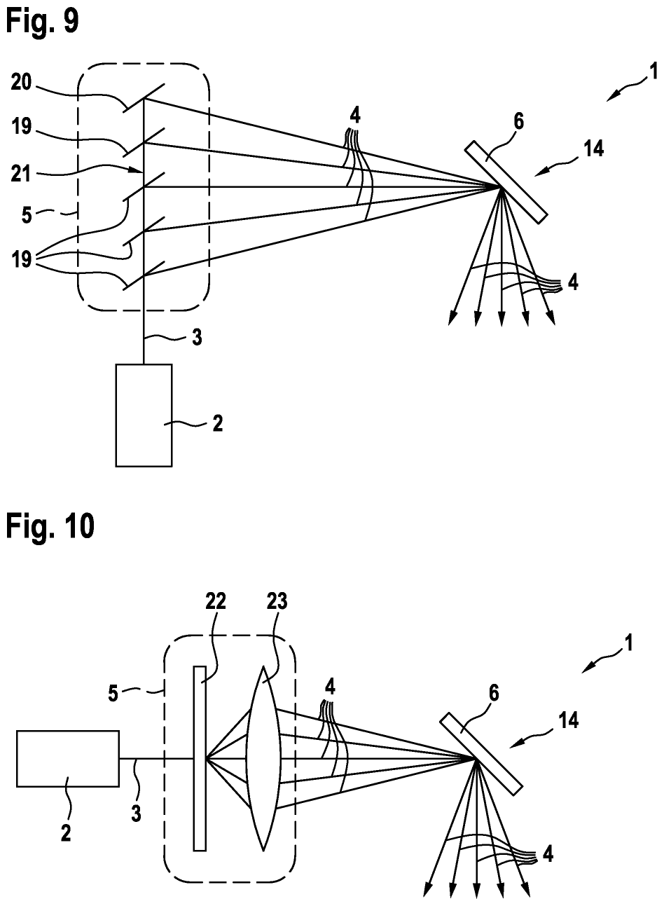

FIGS. 9 and 10 illustrate different embodiments of the beam splitting device 5 of the manufacturing device 1. The beam splitting device 5 shown in FIG. 8 comprises four semitransparent mirrors 19 and at last a fully reflective mirror 20 arranged along the optical paths 21 of the laser beam 3 that is emitted from the laser beam source 2. At each semitransparent mirror 19 a part of the incoming laser beam 3, namely a first subbeam 4 is reflected towards the mirror 6 of the optical means 14 for directing the subbeams 4 towards the layer 11 of small particles 12 of a product material, whereby this layer 11 is not shown in FIGS. 8 and 9. However, the main intensity of the incoming laser beam 3 is transmitted through the first semitransparent mirror 19 towards the following semitransparent mirrors 19. The second, third and fourth semitransparent mirror 19 each reflect a part of the remaining laser beam 3 towards the mirror 6. The final and fully reflective mirror 20 reflects all of the remaining intensity of the laser beam 3 towards the mirror 6, resulting in the last subbeam 4 along the optical path 21 of the laser beam 3. Thus, by arranging four semitransparent mirrors 19 and a fully reflective mirror 20 along the optical path 21 of the laser beam 3 a total of five subbeams 4 are generated by the beam splitting device 5. The orientation of each of the semitransparent mirrors 19 as well as of the fully reflective mirror 20 is such that the subbeams 4 are all focused onto the same spot of the mirror 6.

By changing the distance between the neighboring semitransparent mirrors 19 including the final fully reflective mirror 20 and by adjusting the orientation of each of the emerging subbeams 4 with respect to the mirror 6, the divergence of the subbeams after reflection from the mirror 6 can be altered, and thus the distance of the respective spots on the product material can be altered accordingly. It is also possible to vary the distance between the arrangement of the semitransparent mirrors 19 along the optical path 21 and the mirror 6, and to adjust the orientation of each of the emerging subbeams 4 with respect to the mirror 6, which then also results in a corresponding change of the distance of the respective spots on the product material.

The beam splitting device 5 shown in FIG. 9 comprises a diffraction grating 22 that generates a total of five subbeams 4. A focusing lens 23 focuses the diverging subbeams 4 that emerge from the beam splitting device 5 towards the mirror 6. By changing the diffraction grating 22, a larger or smaller number of subbeams 4 or a larger or smaller divergence of the subbeams 4 can be produced with the beam splitting device 5. Of course, the different embodiments of the beam splitting device 5 can be used with all different embodiments of the one or more optical means 14 that are used within the manufacturing device 1.

1. Method for additive manufacture of a product, comprising a layer arrangement step, whereby a layer (11) of small particles (12) of a product material is arranged, and comprising a solidification step whereby a laser beam (3) is directed at predefined spots (8, 9, 10) within the layer (11) of small particles (12) for heating and connecting the small particles (12) of the product material at said spots (8, 9, 10), resulting in at least one solidified area of product material within the layer (11) of small particles (12), and whereby the product is manufactured by repeatedly performing the layer arrangement step and the solidification step, whereby each solidified area of product material of a subsequently arranged layer (11) is connected with a previously solidified part of the product until the product is generated by interconnected solidified areas of connected product material, characterized in that within the solidification step the laser beam (3) is divided into at least two separate subbeams (4) that are directed at separate spots (8, 9, 10) for simultaneously connecting the small particles (12) of the product material at these separate spots (8, 9, 10).

2. Method according to claim 1, characterized in that the at least two separate subbeams (4) are directed at separate spots (8, 9, 10) at a distance towards each other.

3. Method according to claim 1, characterized in that the at least two separate subbeams (4) are directed at separate spots (8, 9) that partially overlap each other.

4. Method according to claim 1, characterized in that the at least two separate subbeams (4) are directed towards separate optical means (14) for directing the corresponding subbeam (4) towards the respective spot (8, 9, 10) within the layer (11) of small particles (12) of the product material.

5. Method according to claim 4, characterized in that the position of the respective spots (8, 9, 10) of each of the at least two separate subbeams (4) is controlled independently of each other.

6. Method according to claim 1, characterized in that the at least two separate subbeams (4) are directed towards one common means (14) for directing at least two of the at least two subbeams (4) towards the respective spots (8, 9, 10) within the layer (11) of small particles (12) of the product material.

7. Method according to claim 1, characterized in that the laser intensity of the at least two subbeams (4) is controlled to connecting the small particles (12) of the product material by sintering the small particles (12).

8. Method according to claim 1, characterized in that the laser intensity of the at least two subbeams (4) is controlled to connecting the small particles (12) of the product material by melting the small particles (12) in order to connect the small particles (12) by subsequent solidification of the small particles (12) of the product material.

9. Method according to claim 1, characterized in that the product material comprises at least one active ingredient and optionally at least one inactive component for manufacturing a solid pharmaceutical dosage form (15, 17, 18).

10. Manufacturing device (1) for additive manufacturing of a product comprising a laser beam source (2) and an optical means (14) for directing the laser beam (3) towards a layer (11) of small particles (12) of a product material, characterized in that the manufacturing device (1) comprises a beam splitting device (5) that divides the laser beam (3) after emission from the laser beam source (2) into at least two separate subbeams (4) that can be directed towards at least two separate spots (8, 9, 10) for simultaneously connecting the small particles (12) of the product material at these separate spots (8, 9, 10).

11. Manufacturing device (1) according to claim 10, characterized in that the beam splitting device (5) comprises at least one semitransparent mirror that splits the laser beam (3) into at least two separate subbeams (4) that can be directed towards the at least two separate spots (8, 9, 10).

12. Manufacturing device (1) according to claim 10, characterized in that the beam splitting device (5) comprises a diffraction grating that splits the laser beam (3) into at least two separate subbeams (4) that can be directed towards the at least two separate spots (8, 9, 10).

13. Manufacturing device (1) according to claim 10, characterized in that the manufacturing device (1) comprises separate optical means (14) for directing the at least two subbeams (4) towards separate spots (8, 9, 10) within the layer (11) of small particles (12) of the product material.

14. Manufacturing device (1) according to claim 10, characterized in that the manufacturing device (1) comprises one common optical means (14) for directing at least two of the at least two subbeams (4) towards separate spots (8, 9, 10) within the layer (11) of small particles (12) of the product material.

15. Manufacturing device (1) according to claim 10, characterized in that the one or more optical means (14) for directing the at least two subbeams (4) comprise one or more mirrors (6) that reflect the incoming one or more subbeams (4) towards the respective spots (8, 9, 10).

16. Manufacturing device (1) according to claim 10, characterized in that the one or more optical means (14) for directing the at least two subbeams comprise one or more focusing device for focusing the one or more incoming subbeams (4) onto the respective spots (8, 9, 10).

17. Manufacturing device (1) according to claim 16, characterized in that the focusing device comprises or is a f-theta lens (7) system.

18. Manufacturing device (1) according to claim 10, characterized in that a distance between the beam splitting device (5) and the one or more optical means (14) for directing the at least two subbeams (4) can be varied in order to vary a distance of the respective spots (8, 9, 10) accordingly.

19. Manufacturing device (1) according to claim 10, characterized in that the direction of the subbeams (4) emerging from the beam splitting device (5) can be varied in order to vary a distance of the respective spots (8, 9, 10) accordingly.

20. Manufacturing device (1) according to claim 10, characterized in that the laser beam source (2) is a laser source suitable for additive manufacturing methods like selective laser sintering, e.g. a carbon dioxide laser source, a Nd:YAG laser source or an optical fiber laser.

21. Solid pharmaceutical dosage form (15, 17, 18), characterized in that the solid pharmaceutical dosage form (15, 17, 18) is manufactured by a method according to claim 1.
